(19) United States
(12) Patent Application Publication
(10) Pub. No.: US 2002/0044684 A1
(43) Pub. Date: Apr. 18, 2002

(54) Data processor and method of data processing

(76) Inventor: Jason Charles Pelly, Reading (GB)

Correspondence Address: FROMMER LAWRENCE & HAUG LLP, 745 FIFTH AVENUE, NEW YORK, NY, 10151, US

(21) Appl. No.: 09/945,985

(22) Filed: Sep. 4, 2001

(30) Foreign Application Priority Data
Sep. 5, 2000 (GB) 0021769.5

(51) Int. Cl. G06K 9/00; G06K 9/36; G06K 9/46

(52) U.S. Cl. 382/166; 382/238

(57) ABSTRACT

A data processor is operable to represent data symbols from a data source as modelled data symbols. The data source has first component data (R) and second component data (G), the first component data being related to the second component data. The data processor comprises a prediction processor operable to generate first modelled data symbols representative of the first component data symbols, by predicting each of the first component data symbols from the second component data symbols. A predicted value for each first component symbol may be generated by forming a difference between a preceding first component symbol and a preceding second component symbol, corresponding to the preceding first component symbol, and subtracting the difference from a second component data symbol corresponding to each first component symbol, calculating a prediction error for each first component symbol by subtracting from each first component symbol, the prediction value corresponding to the first component symbol, and generating the modelled data symbols from the prediction errors. The data processor thereby models the first component from the second component. The modelled data symbols may be more efficiently compression encoded, in particular where the first and second components are correlated. The invention finds particular application in compression encoding color images where the first component corresponds to one of red, green or blue components of the color image and the second component corresponds to one of the other red, green or blue components.

### FIELD OF THE INVENTION

The present invention relates to data processing apparatus and methods which serve to transform data symbols from a data source into transformed data symbols, which represent the information content of the source data but which have a different probability of occurrence, than the original source data symbols.

The present invention also relates to data compression encoders and data compression decoders.

### BACKGROUND OF INVENTION

There are many applications in which it is beneficial to transform source data symbols into another form in which the transformed data symbols have a different probability of occurrence, whilst still representing the information content of the original source data. A process in which data symbols from a source are transformed into data symbols having a different probability of occurrence is known as modelling or pre-processing. Typically the modelled data symbols have a reduced redundancy in comparison to the original source data symbols.

An example application of modelling is in the field of data compression encoding. Data compression encoders are capable of compressing an amount of source data into a substantially reduced amount of compression encoded data. For some forms of compression encoding there is no loss of information when the source data is compression encoded, although in other forms information is deliberately discarded to improve the compression encoding efficiency. An example of a loss-less coding process is the Joint Photographic Experts Group (JPEG) encoding process, which is typically applied to digital representations of still images generated by, for example, digital video cameras. The JPEG encoding process is known to employ Huffman coding in order to effect data compression. Huffman coding is an example of a data compression encoding algorithm which benefits from a pre-process of modelling the source data. In common with other compression encoding algorithms, Huffman coding provides greatest data compression for data sources with low entropy. The purpose of the modelling pre-process is to convert the symbols of the data source into modelled data symbols having lower entropy.

For the example of loss-less JPEG, the modelling step is known as Differential Pulse Code Modulation (DPCM) modelling. In DPCM modelling, the entropy of the source data is reduced by generating an estimate of each of the source data symbols from a plurality of preceding source data symbols weighted respectively by a corresponding weighting factor and forming a new data stream with modelled data symbols representative of a prediction error formed from a difference between each prediction of the data symbols and the original data symbols.

Generally, modelling pre-processes are most successful, if the prediction of each source data symbol, generated in the pre-process, is as close as possible to the original source data symbol. Accordingly, it is desirable to provide a modelling process which produces modelled data symbols for a data source which utilises a characteristic of the data source to improve prediction.

### SUMMARY OF INVENTION

According to the present invention there is provided a data processor operable to represent data symbols from a data source as modelled data symbols, the data source having first component data and second component data, the first component data being related to the second component data, the data processor comprising a prediction processor operable to generate first modelled data symbols representative of the first component data symbols, by predicting each of the first component data symbols from preceding first and the second component data symbols.

A data processor operating in accordance with the present invention utilises a degree of correlation that can exist between the probability of occurrence of data symbols from each of a plurality of components of a data source. An improved modelling process is provided by predicting one of the components from the other component. For example, the components of a colour image are comprised of red, green and blue pixels. For a typical colour image, the red, green and blue pixels values of the colour image are correlated. That is to say, there is, to some extent, a relationship between the pixel values of each component. Accordingly, an embodiment of the present invention utilises this correlation by predicting for example the red component from the green component.

In preferred embodiments, the prediction processor may be operable to determine the prediction value for each first component symbol by forming a difference between a preceding first component symbol and a preceding second component symbol, corresponding to the preceding first component symbol and subtracting the difference, from a second component data symbol corresponding to each first component symbol, to calculate a prediction error for each first component symbol by subtracting from each first component symbol the prediction value corresponding to the first component symbol, and to generate modelled data symbols from the prediction errors.

Advantageously, in order to reduce the alphabet size of the modelled data symbols, the prediction processor may be arranged in operation to generate the modelled data symbols from each prediction error modulus the alphabet size of the modelled data symbols. The prediction error is formed by subtracting the current symbol value from the predicted value. As a result, if the current symbol can have N possible values then the prediction error can have 2N−1 possible values. However the prediction error can only take N possible values, so that taking the modulus reduces the alphabet size back to N.

Although the data processor generates the first modelled data symbols by predicting each of the first data symbols from the second, it is often desirable to generate modelled data symbols which are representative of the second component so that all the information from the data source can be converted into modelled data symbols having a different probability of occurrence from that of the source symbols. As such the data processor may further comprise a second prediction processor operable to generate second modelled data symbols representative of the second component data symbols, by predicting each of the second component data symbols from preceding second component data symbols and forming the second modelled data symbols from a difference between the original second component symbols and the prediction.

In preferred embodiments, the second prediction processor may operate in accordance with Differential Pulse Code Modulation (DPCM).

According to another aspect of the present invention there is provided a data compression encoder operable to pre-process source data having more than one component, and to compression encode the modelled data symbols in accordance with a compression encoding process. Accordingly, an aspect of the present invention also provides a data compression decoder.

It will be appreciated that Huffman coding has been used as an example only of a data compression encoding algorithm and that therefore embodiments of the invention are not limited to any particular form of data compression encoding. More particularly, the invention finds application in both loss-less data compression encoding and compression encoding in which information is discarded.

Another aspect of the present invention provides an improved data modelling pre-process operable to predict one component from two other components of a colour image.

Various further aspects and features of the present invention are defined in the appended claims.

### BRIEF DESCRIPTION OF DRAWINGS

Embodiments of the present invention will now be described by way of example only with reference to the accompanying drawings wherein:

FIG. 1 is a schematic block diagram of a general data compression encoder and decoder arrangement,

FIG. 2 is a schematic block diagram of the data compression encoder which appears in FIG. 1,

FIG. 3 is a graphical representation of the pixel values for each of the red, green and blue components within a sample test colour image,

FIG. 4 is a graphical representation of the pixel values for each of the red, green and blue components within a further sample test colour image,

FIG. 5 is a schematic block diagram of a more detailed representation of the pre-processor appearing in FIG. 2,

FIG. 6 is a representation of the operation of one of the pre-processors appearing in the data compression encoder shown in FIG. 2,

FIG. 7 is a schematic illustration of the operation of the DPCM modelling process,

FIG. 8 is a schematic block diagram of a data compression decoder shown in FIG. 1,

FIG. 9 is a schematic block diagram of a more detailed representation of a post-processor of the decoder appearing in FIG. 8,

FIG. 10 is a schematic block diagram of a further example of a pre-processor,

FIG. 11 is a flow diagram illustrating the operation of the pre-processor shown in FIG. 11, and

FIG. 12 is a schematic block diagram of a further example of a post-processor corresponding to the pre-processor shown in FIG. 10.

### DESCRIPTION OF PREFERRED EMBODIMENTS

As explained above, embodiments of the present invention provide a modelling process which finds application in fields where it is beneficial to change the probability of occurrence of data symbols from a data source. One example application is in the field of data compression encoding. By pre-processing the data symbols from a source in accordance with the modelling process, the probability of occurrence of the modelled data symbols can facilitate a more efficient compression encoding process.

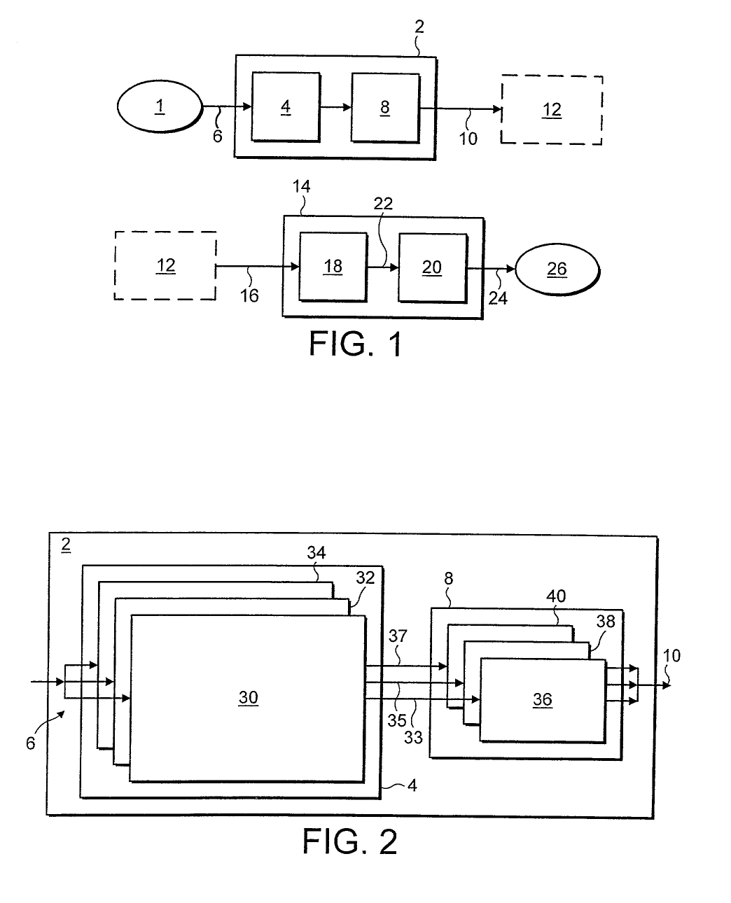

FIG. 1 provides a block diagram of a general arrangement in which source data is compression encoded and compression decoded and supplied to a sink for the data. In FIG. 1 a source of data 1 is arranged to feed source data symbols to a data compression encoder 2. Within the data compression encoder 2 the source data symbols are received by a pre-processor 4 via a connecting channel 6. Also forming part of the compression encoder 2 is a data compression encoding processor 8 to which pre-processed data symbols provided at the output of the pre-processor 4 are fed. The encoding processor 8 feeds compression encoded data corresponding to the source data to an output channel 10. The compression encoding algorithm performed by the encoding processor 8 compresses the source data into compression encoded data having a considerably reduced volume of data. The compression encoded data is then fed to a channel or storage medium shown generally as a box 12. To illustrate the process of data compression decoding, FIG. 1 also shows the compression encoded data being recovered and communicated to an input of a data compression decoder 14 fed from the channel of the storage medium 12 via a connecting channel 16. The data compression decoder comprises a compression decoding processor 18 connected to a post processor 20. The post-processor 20 receives compression decoded data symbols from an output of the decoding processor 18 via a connecting channel 22. The post processor operates to reverse the operation of the pre-processor 4 of the encoder 2 and to provide at an output 24 an estimate of the source data which is fed to a sink 26.

Although the example embodiment of the present invention will be illustrated with reference to encoding digital images, it will be appreciated that the invention finds application with other types of data.

The compression encoder 2 which appears in FIG. 1 is shown in more detail in FIG. 2 where parts also appearing in FIG. 1 have the same numerical designation. For the example in which the source is representative of a colour digital image, the data compression encoder 2 must encode effectively three different source data streams which are representative of the red, green and blue components of a colour image. Accordingly, the compression encoder 2 shown in FIG. 2 operates to pre-process and compression encode each of the three components of the colour image. As such the pre-processor 4 is shown in FIG. 2 to have three data processors 30, 32, 34 which are arranged respectively to receive data symbols corresponding to the red, green and blue components of the colour image. Correspondingly, the compression encoding processor 8 is shown to include three further processors 36, 38, 40 each of which is arranged respectively to compression encode the pre-processed data symbols provided respectively at the output channels 33, 35, 37 of the three data processors 30, 32, 34.

The function and purpose of the pre-processor 30, which may also be described as a “modeller”, is to transform the source data symbols received via the connecting channel 6 into a new stream of modelled data symbols having a lower entropy. As is known to those skilled in the art the term entropy as applied to an information source is a measure of the relative amount of information provided by the symbols of that source. If the symbols of the data source 1 occur with a probability of pi where i=1 to n, then the entropy of the data source is calculated in accordance with equation (1).

$$H ( {p}_{1} … {p}_{N} ) = - {\sum }_{i = 1}^{N} {p}_{i} {log}_{2} ( {p}_{i} ) \qquad ( 1 )$$

In effect the operation of the pre-processor is to model the data source to the effect of reducing the entropy of the data source so that the data compression encoder following the pre-processor can encode the data with greater efficiency. This is because data compression encoding algorithms are able to increase the compression ratio for data sources having symbols which occur with a range of probabilities producing a concentrated ‘peaky’ distribution rather than a flat distribution in which data symbols occur with a more equal probability. This will be further illustrated in subsequent paragraphs.

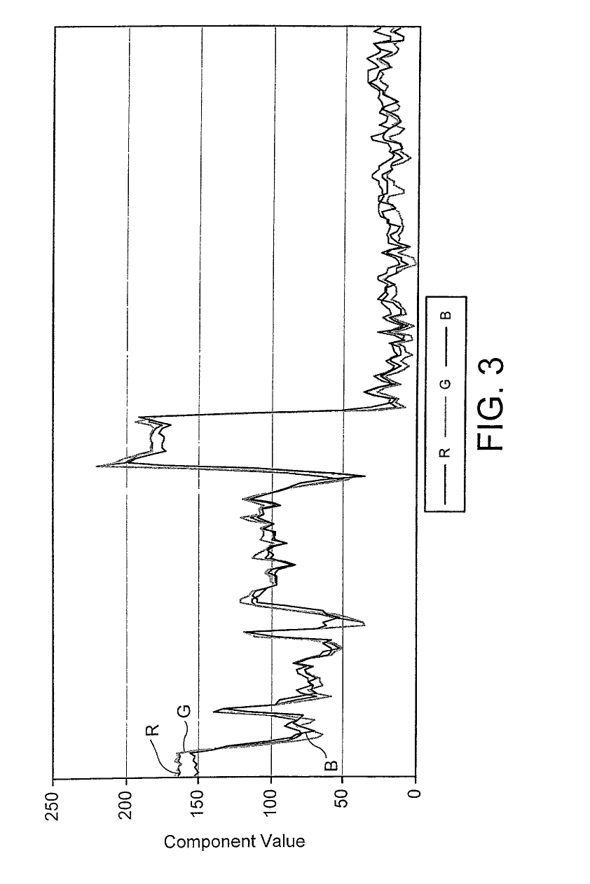

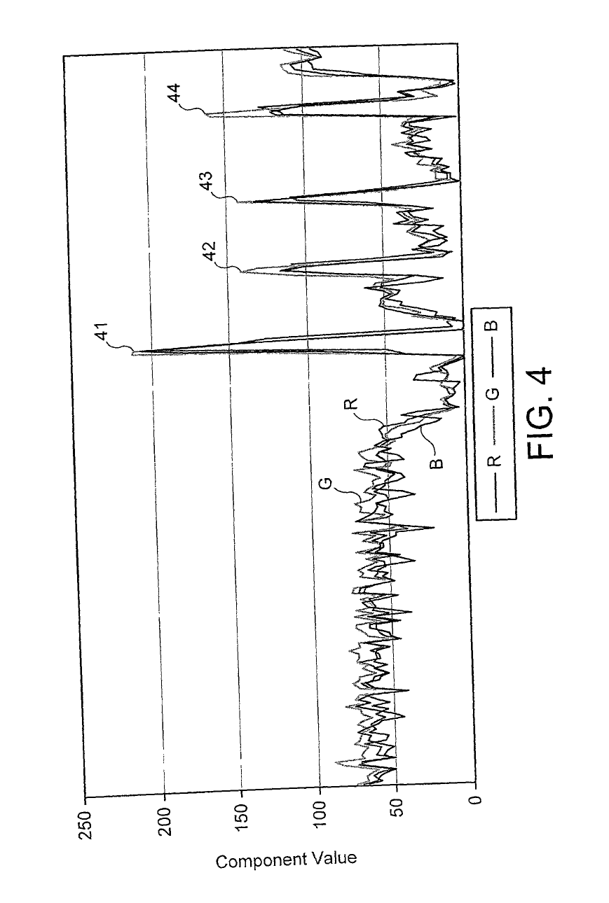

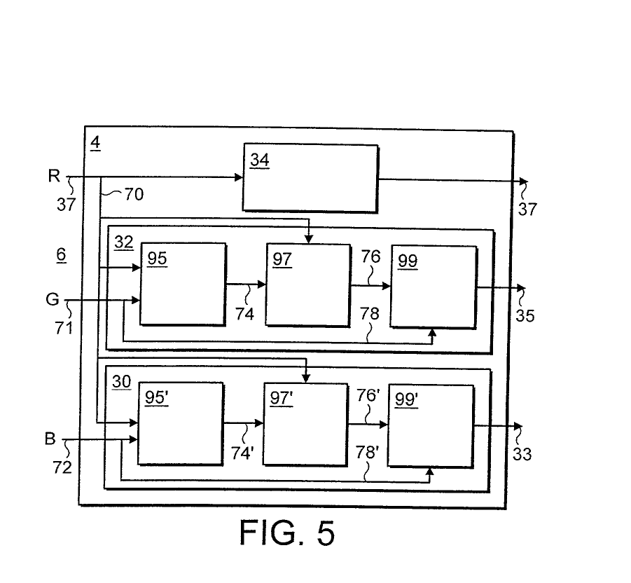

For the present example embodiment the data source is producing digital images so the pre-processor is arranged to convert the symbols of each of the components of the colour image into modelled data symbols. However, as will be explained in the following paragraphs, the three components of the image are modelled differently. This is because the embodiment of the present invention is arranged to utilise a correlation which often exists between the three colour components of a colour image. This is illustrated for two test images by a graphical representation of pixel values for each of the three components of the images shown in FIGS. 3 and 4. In FIGS. 3 and 4, the red, green and blue components R, G, B of the two test images are each shown by a line plotted for each pixel position of the image with respect to pixel value. As can be observed for the two example test images, the three components R, G, B appear to follow each other closely. For example in FIG. 4, four peaks 41, 42, 43, 44 in the pixels values for each of the three components appear to track each other closely. As such there appears to be a strong correlation between the pixel values of the image. It is this correlation which is utilised by the modelling pre-process to predict two of the three components from the other component, in order to generate modelled data symbols which have a lower entropy and can be therefore more efficiently compression encoded. This modelling process is referred to in the following description as Component Differential Prediction (CDP) modelling. The other component is referred to as a reference component, which in the example embodiment is the red component. However it will be appreciated that any of the other components could be used as the reference component. The modelling pre-processor 4 shown in the compression encoder 2 in FIG. 2 is illustrated in more detail in the block diagram shown in FIG. 5, where parts also appearing in FIGS. 1 and 2 have the same reference numerals.

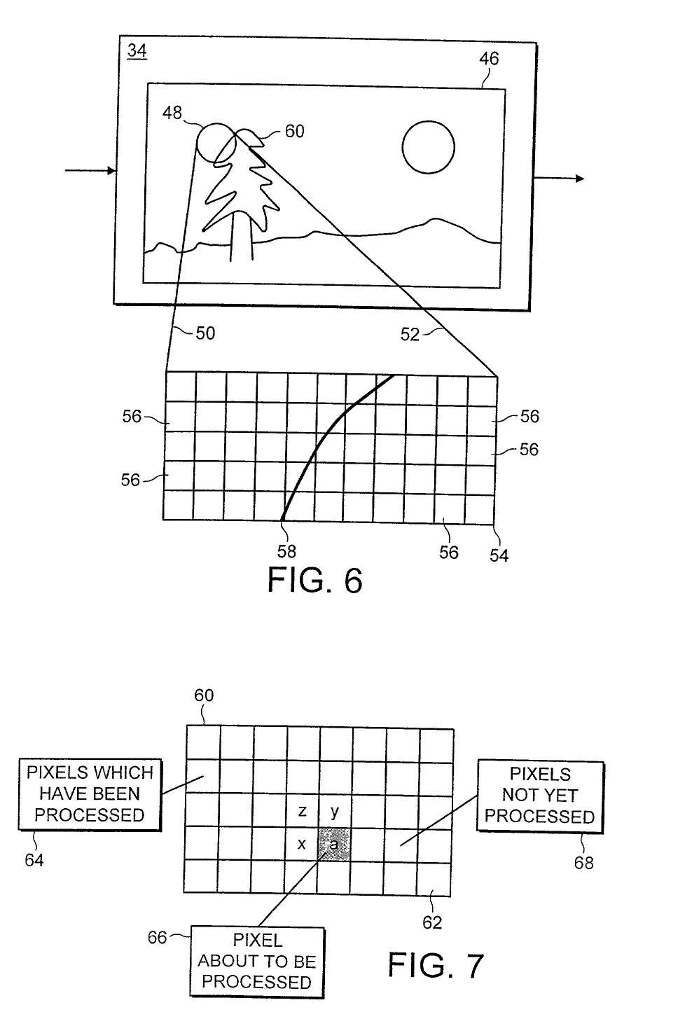

In FIG. 5, the data processors 30, 32, 34 are shown in more detail. The data processor 34 is shown as a single processor, whereas the two other data processors 30, 32 are shown to include three further processing units 95, 97, 99. The red component, which in the example embodiment is the reference component R is fed to the data processor 34, and the green G, and blue B components are fed respectively to the other two data processors 30, 32. In order to explain the operation of the pre-processor 4, a modelling technique which is applied to the red reference component will be explained first. The reference component must be derivable from the modelled data symbols representing the reference component data symbols alone at the data compression decoder 20 without reference to the other two components. Therefore the data processor 34, assigned to pre-process the red component is arranged to operate in accordance with the DPCM modelling process which will now be briefly explained, with reference to FIGS. 6 and 7. However, a more detailed explanation of the DPCM modelling process and the Variable Weight DPCM modelling process, which are incorporated herein by reference is disclosed in our co-pending UK patent application serial number 0014890.8

In FIG. 6 the data processor 34 is arranged to process the red pixels representative of the red component of a digital image 46. As shown in FIG. 6 a part of the image 48 falling within the image 46 is shown in expanded form as represented by lines 50, 52 by a group of pixels within a box 54. The box 54 comprises squares 56 each of which is representative of a red pixel of the image component 48. As shown in the box 54 a line 58 forms part of an object within the image component 46. In this example this line 58 is part of a tree 60. As will be observed from the expanded form of the part of the image 48 shown in FIG. 6, most of the pixels within the part of the image are representative of the same relative magnitude and therefore the same value, apart from those pixels which make up the line 58. It is a result of a feature that typical images have large areas which correspond to the same pixel values which is utilised by the pre-processor 34 to reduce the entropy of the source.

As illustrated in FIG. 7, the pre-processor 34 progresses through the image, from a top-left pixel 60 to a bottom-right pixel 62, row by row. The pre-processor 34 is considered to have processed pixels in position 64, and is about to process the pixel whose value is a at position 66 and has still to process pixels in positions 68. Since the values x, y and z are known, it is possible to obtain from them a prediction pₐ of the value of a. For example:

pₐ=x+y−z (2)

or

$${p}_{a} = \frac{2 x + 2 y - z}{3} \qquad ( 3 )$$

or, a general linear predictor is given by

$${p}_{a} = \frac{{w}_{x} x + {w}_{y} y + {w}_{z} z}{{w}_{x} + {w}_{y} + {w}_{z}} \qquad ( 4 )$$

from some weights wₓ, w_{y} and w_{z} where wₓ+w_{y}+w_{z}≠0.

Naturally, other pixels could be used to form the prediction. Indeed, a simple one-dimension predictor can be formed by merely looking at a single previous pixel value. However, two-dimensional predictors are usually far superior to the one-dimensional version. Predictors in the form of equation (4) are of the simplest form for a two-dimensional predictor.

There are special cases to consider:

For the pixel at the very top left corner of the image, no prediction can be made as this is the first pixel to be processed. In such a case, the prediction value is taken to be 0 (as will be appreciated other pixel values may be used).

For pixels on the very top row, only a one-dimensional predictor is possible, for example, pₐ=x would suffice.

For pixels on the very left column, there are no pixels further to the left, so a prediction such as pₐ=y is often used.

Once a prediction has been formed, the prediction error, eₐ, can be calculated from equation (5).

eₐ=a−pₐ (5)

It is then this error eₐ which is used to form the modelled data symbols as output by the modelling pre-processor 34 and input to the compression encoder 40. If good predictions are made by the pre-processor 34, then the frequency counts for values of eₐ close to 0 will be very large. This assists the encoder, as a data stream having only a few symbols with high frequency lends itself well to compression, as opposed to all the symbols having a similar probability. However, the number of permissible symbols has increased. If there are N possible pixel values (ranging from 0 to N), then this form of DCPM modelling increases the alphabet size to be 2N−1 possible values. This can be avoided, though, by observing that, for a given prediction pₐ, the prediction error can only take N possible values. Therefore, the prediction error can be taken to a modulus of N as expressed by equation (6).

eₐ=(a−pₐ)mod(N) (6)

This means that performing DCPM modelling does not require an increase in the alphabet size. As will be explained later, the post-processor 20 operates to perform a reverse modelling process. The reverse modelling is effected by generating from a prediction, pₐ, of the pixel value, a, by reversing the operation performed by the pre-processor. The reverse modelling is performed by a post-processor which receives the value v=(a−pₐ)mod(N). The pixel value can therefore be obtained from

a=(v+pₐ)mod(N) (7)

The pre-processing of the remaining two green and blue components by the other two data processors 30, 32 will now be described.

As a result of the correlation between the three components of the colour image the data processors 30, 32 operate to generate a modelled data symbol stream for the blue and green input data streams with reference to the red input data stream. Each of the two data processors is provided with a correlation evaluator 35, which receives the red component data symbols via a connection 70 and the data symbols for the green or blue component for which the modelled data symbols are to be derived. The following description will be made with reference to the green component, although it will be appreciated that the blue component is modelled correspondingly and so the explanation does not need to be repeated. The correlation evaluator 35 is arranged in operation to determine for each green pixel a correlation value from the difference between the preceding green pixel and the preceding red pixel value. This is expressed as equation (8):

diff=\hat{R}−Ĝ (8)

The correlation values (diff) for each green pixel are then fed to a predictor 37. The predictor serves to determine a prediction for each green pixel based on the correlation value for that green pixel and the corresponding red pixel value by subtracting the correlation value (diff) from the corresponding red pixel value. This is expressed by equation (9):

G_{pred}=R−diff (9)

Finally, it is the error in the prediction value which is sent to the encoder. This is generated by an error predictor 39, which receives the prediction for each green pixel via connecting channel 76, and the original green pixel value via a second connecting channel 78. The error predictor operates to generate a prediction error for each green pixel in accordance with equation (10):

error=(G−G_{pred})mod(N) (10)

The error is then converted by the modulus of the alphabet size of the pixel values N. As with DPCM modelling this is to prevent the alphabet size increasing to 2N−1. Again taking the modulus is permitted, since the modelling process and the reverse modelling process performed at the post processor of the decoder 20 will be provided with the values of \hat{R}, Ĝ and R and hence both the pre-processor and the post-processor can determine the value of G_{pred}. There are therefore only N possible values for G−G_{pred}.

The modelling process is reversed in the decoder 20, by performing the compression decoding and post-processing the modelled data symbols recovered from the decoding process to the effect of performing reverse modelling. The reverse modelling for the green component is effected for each pixel by equation (11):

G=(G_{pred}+error)mod(N) (11)

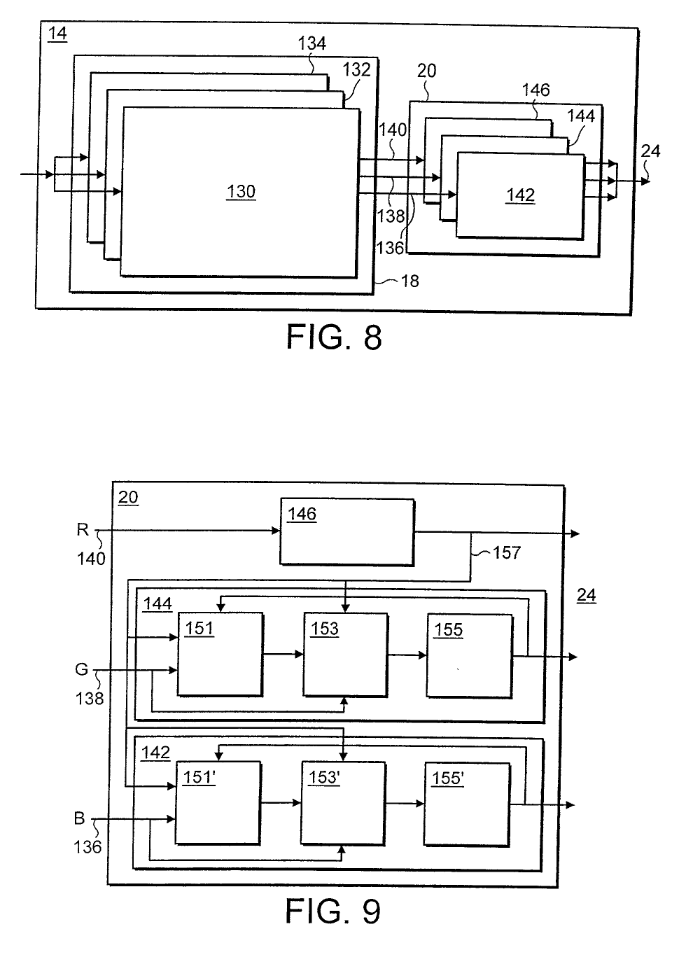

As will be appreciated the data compression decoder 18 which is shown in FIG. 1 will operate to perform the reverse of the data compression encoding and the post-processor 20 will operate to perform the reverse modelling. In the case of the red component this will be a reverse of the DPCM modelling process. For the green and blue components this will be a reverse of the CDP modelling process. The data compression decoder 14 is shown in more detail in FIG. 8 where parts also appearing in FIG. 1 have the same numerical designations.

As with the data compression encoder, the decoder divides the colour image signal into each of the red, green and blue components. Each of the encoded parts of the image signal are fed respectively to a data compression decoding processor 130, 132, 134 which form part of the decoding processor 18. The decoding processors 130, 132, 134 for example operate to effect reverse operation to the compression encoding algorithm and generates an estimate of the modelled data symbols for the red, green and blue components as were present at the input of the data compression encoder.

In FIG. 8, the modelled data symbols for the red, green and blue components are fed respectively from the corresponding connecting channels 136, 138, 140 to the processing units 142, 144, 146. The post-processing unit 146, operates to effect reverse DPCM modelling according to equation (7). The green and blue components are fed to the other two post-processing units 142, 144, each of which has a correlation evaluator 151, a prediction processor 153 and an output processor 155. As with the pre-processor, the operations of the post-processing units 142, 144 for the green and blue components are the same and so only the operation of the post-processing unit 144 for green component will be described.

The post-processing unit 144 is shown in more detail in FIG. 9, where parts also appearing in FIGS. 1 and 8 have the same numerical designations. In accordance with the reverse of the CDP modelling process the modelled symbols for the green component are received at the correlation evaluator 151. The estimates of the red pixels generated by the post processing unit 146 are required in order to re-generate the green pixels and so are fed to the correlation evaluator 151 received from a connecting channel 157. The correlation evaluator generates for each modelled data symbol a correlation value according to equation (8) above. This is generated using estimated pixel values provided via a fed back channel 159, 159′ from the output processor 155, 155′. However an estimate of the value of the first green component Ĝ is required. This is provided by using an initial symbol value, which is known to the post-processing unit. The initial symbol value is therefore known at the pre-processor and the post-processor and so can be used to generate the first correlation value. The correlation values for each of the modelled data symbols are then fed to the prediction processor 153. The prediction processor 153, also receives the estimated pixels values for the red component from the output of the post-processing unit 146 via the connecting channel 157. The prediction processor 153 generates a prediction value for each green pixel from the red pixel value by subtracting the correlation value from the red pixel value which corresponds to the modelled data symbol being reverse modelled, according to equation (9). Finally the output processor 155 re-generates an estimate of each of the green pixel values, by adding the corresponding modelled data symbol to the prediction value for each green pixel value according to equation (11). Finally therefore the estimates of the data symbols for the red, green and blue components are output on the connecting channel 24.

Second Embodiment

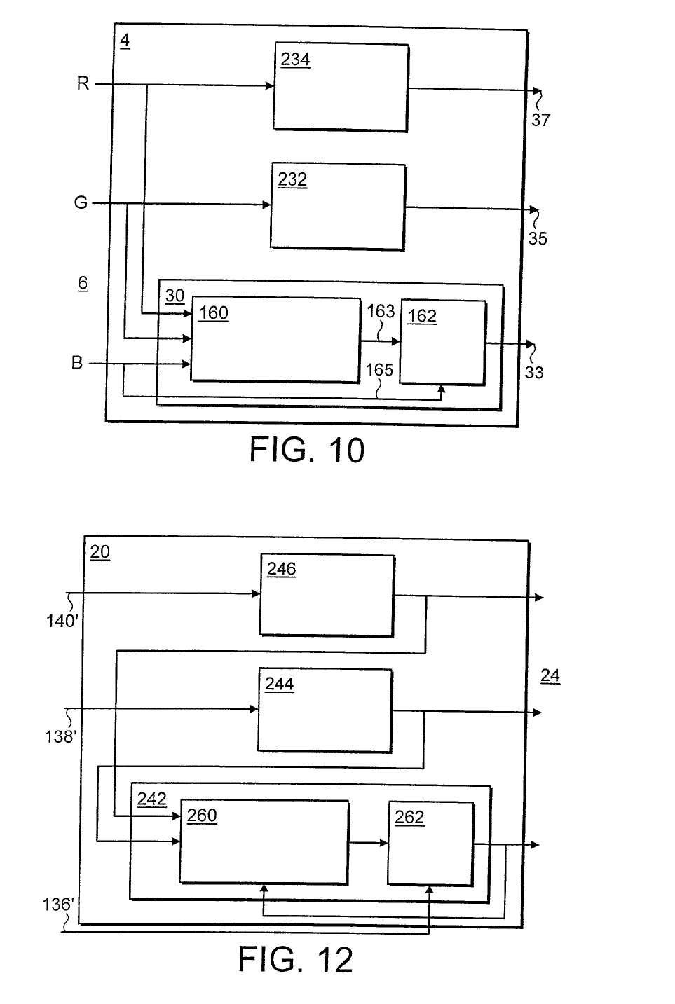

A second embodiment of the present invention is illustrated by a block diagram of a further example of the pre-processor 4, which is shown in FIG. 10, where parts also appearing in FIG. 5 have the same reference numerals. The pre-processor shown in FIG. 10 operates in accordance with a further Component Differential Modelling process, in which one of the components is derived from the two others of the three image components. The pre-processor 4 of the second embodiment operates in a similar manner to the pre-processor of the first embodiment and so only the differences between the two will be described. In FIG. 10 the first and second data processors 232, 234 both operate to model the red and green components in accordance with DPCM process. As such both will be available at the post-processor to derive the remaining blue component. The data processor 30 for the blue component models the blue pixel values under an assumption that the ratio of the component differences can be taken to be the same between adjacent pixels. Under this assumption, equation (12) holds:

$$\frac{G - B}{R - G} = \frac{\hat{G} - \hat{B}}{\hat{R} - \hat{G}} \qquad ( 12 )$$

For this assumption, a prediction of the value of the blue component pixels can be made according to the following pseudo code: If

$$\hat{R} \neq \hat{G} , t h e n {B}_{p r e d} = G - \frac{( \hat{G} - \hat{B} ) ( R - G )}{( \hat{R} - \hat{G} )} e l s e , \qquad ( 13 )$$

\hat{R}=Ĝ, then B_{pred}=G−(Ĝ−\hat{B}) (14)

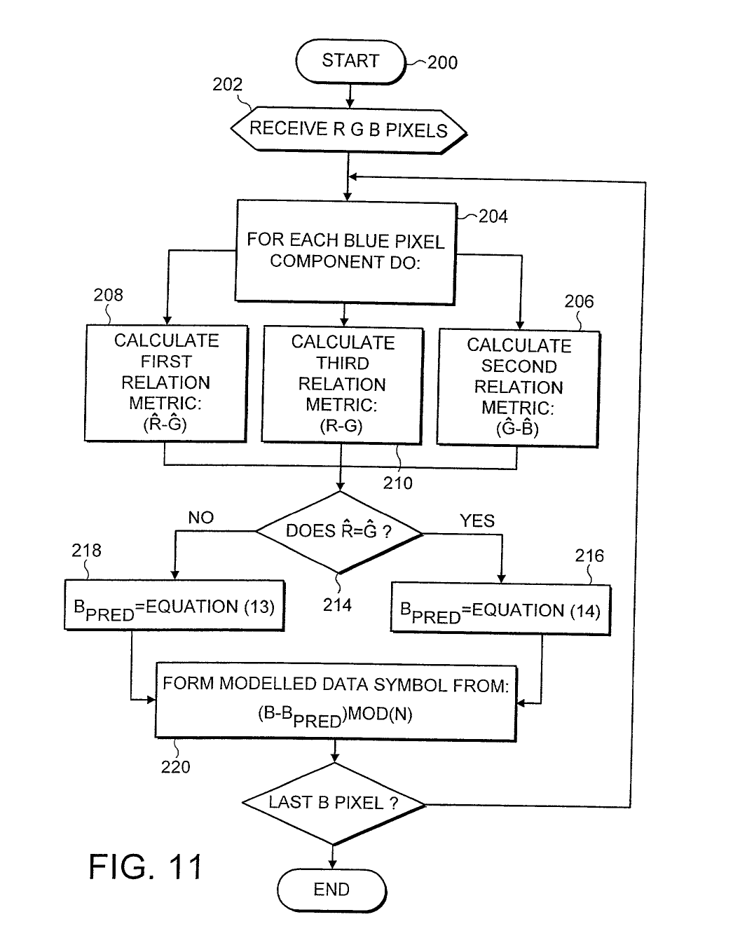

The data processor 30 is shown to comprise a prediction processor 160, and an evaluation processor 162. In order to perform this modelling, the data processor 30 therefore operates in accordance with the following process, which is also illustrated by the flow diagram shown in FIG. 11. From the start 200, the red, green and blue pixels are received at the prediction processor 160, as represented by process step 202. For each blue data symbol (process step 204), a first relation metric (Ĝ−\hat{B}) (step 206) and a second relation metric (\hat{R}−Ĝ) (step 208) are determined. The first relation metric is generated from a difference between a preceding green pixel and a preceding blue pixel value at process step 206. The second metric is generated from a difference between a preceding red pixel value and a preceding green pixel value at process step 208. Then for each blue pixel a third relation metric (R−G) is calculated from a difference between a corresponding red pixel value and a corresponding green pixel value at process step 210. For each blue pixel value, a test is performed as to whether the preceding red pixel value is equal to the preceding green pixel value at process step 214. At decision point 214 if the preceding red and green pixel values are equal (\hat{R}=Ĝ), then a prediction is made of the blue pixel from a difference between the corresponding green pixel value and the corresponding first relation metric (Ĝ−\hat{B}). This is effected at process step 216 according to equation (14). However if the preceding red and green pixel values are not equal (\hat{R}≠Ĝ), then a prediction is made of the blue pixel value from the corresponding green pixel value and a ratio of the first and second relation metrics scaled by the third relation metric. This is effected by process step 218.

As shown in FIG. 10, the evaluation processor 162 is arranged to receive the prediction values for each blue pixel via a connection 163. The evaluation processor 162, also receives the blue pixel values from a connecting channel 165. Once a prediction has been made for each of the blue components, then the modelled data symbols for the blue components are generated as before from a prediction error formed between the blue pixel value and the corresponding prediction for the blue pixel value, modulus the alphabet size (N) of the pixel values. This is expressed by equation (15), and is represented in the flow diagram by process step 220:

e_{blue}=(B−B_{pred})mod(N) (15)

The modelled data symbols are formed from the prediction error for each of the blue pixels according to equation (15) by the evaluation processor 162, and are sent to the data compression encoder.

A post-processor which operates to effect the reverse modelling process for the second embodiment is shown in FIG. 12, where parts also appearing in FIG. 8 have the same numerical designations. The blue component is derived at the post-processor from the green and red components. To this end, two of the post-processing units 244, 246 are arranged to receive the modelled data symbols corresponding to the red and green pixel values respectively from the connecting channels 138′, 140′. These two post-processing units 244, 246 are arranged to generate estimates of the red and green pixels by performing the DPCM reverse modelling process already explained. The estimates of the red and green pixels are then output. However the estimates of the red and green components are also fed to two input channels of the third post-processing unit 242. The third post-processing unit 242 also receives the modelled data symbols for the blue component and operates to effect reverse CDP modelling. The third post-processing unit 242 is provided with a prediction processor 260 which generates a prediction for each of the blue pixel values following equation (13) and (14) and steps 200 to 218 of the flow diagram shown in FIG. 11, except that now the estimates of the red and green pixels are used instead of the original red and green pixel values which were known at the encoder. The prediction values for each modelled data symbol are then fed to an output processor 262 which also receives the modelled data symbols via a connection 136′. Finally the blue pixel values are recovered by adding to each of the prediction values the modelled data symbol for the corresponding blue pixel to generate an estimate of the blue pixel values according to equation (15). The estimates of the blue pixels are then provided at the output channel 24.

Although the example embodiment has been described with reference to an application in which an image is data compression encoded, it will be appreciated that embodiments of the invention find application in compression any form of data having a plurality of components and is particularly effective when there is a correlation between these components. Various modifications may be made to the example embodiments described herein without departing from the scope of the present invention. In particular it be understood that a signal representing data encoded in accordance with the present invention forms an aspect of the present invention.

As will be appreciated from the above explanation, an aspect of the present invention also provides an image processor arranged in operation to compression encode a source image comprising three components of first, second and third data, the image processor comprising a pre-processor which is arranged to receive the first, second and third components and to generate first modelled data symbols and second modelled data symbols representing the first and the second image component data from the third image component data, and a compression encoding processor coupled to the pre-processor, which is arranged in operation to compression encode the first and the second modelled data symbols and symbols of the third component data into compression encoded data symbols, wherein the pre-processor generates prediction values of the first component symbols and the second component symbols from the third component symbols, and forms each of the first modelled data symbols from an error between each first component symbol and the corresponding prediction value for each first component symbol, and forms each of the second modelled data symbols from an error between the second component symbol and the corresponding prediction value for the second component symbol. The first, second and third component data may be representative of red, green and blue components, the image being a colour image.

I claim:

1. A data processor operable to represent data symbols from a data source as modelled data symbols, said data source having first component data and second component data, said first component data being related to said second component data, said data processor comprising a prediction processor operable to generate first modelled data symbols representative of said first component data symbols, by predicting each of the first component data symbols from preceding first and said second component data symbols.

2. A data processor as claimed in claim 1, wherein said first prediction processor is operable
to determine the prediction value for each first component symbol by forming a difference between a preceding first component symbol and a preceding second component symbol, corresponding to said preceding first component symbol, and subtracting the difference from a second component data symbol corresponding to said each first component symbol,
to calculate a prediction error for each said first component symbol by subtracting from each said first component symbol said prediction value corresponding to said first component symbol, and
to generate said modelled data symbols from said prediction errors.

3. A data processor as claimed in claim 2, wherein said modelled data symbols are generated from each prediction error modulus the alphabet size of said source data symbols.

4. A data processor as claimed in claim 1, comprising
a second prediction processor operable to generate second modelled data symbols representative of said second component data symbols.

5. A data processor as claimed in claim 4, wherein said second prediction processor is operable to generate said second modelled data symbols, by predicting each of said second component data symbols from preceding second component data symbols and forming said second modelled data symbols from a difference between the original second data symbols and the prediction.

6. A data processor as claimed in claim 5, wherein said second prediction processor is operable to generate second modelled data symbols representative of said second source data symbols, by
generating a prediction for each said second component symbol from at least one preceding second component symbol and at least one other preceding second component symbol weighted by a corresponding weighting factor, and
generating a prediction error from a difference between said each second component symbol and said prediction for each second component symbol,
forming said second modelled data symbols from said prediction error of said each second component symbol.

7. A data processor as claimed in claim 4, wherein said second prediction processor operates in accordance with Differential Pulse Code Modulation (DPCM).

8. A data processor operable to generate an estimate of the first and second component source data symbols from the first modelled data symbols generated by the data processor claimed in claim 1, said data processor comprising a reverse processor operable to generate a prediction for each first component symbol corresponding to each first modelled data symbol by subtracting a difference between a preceding second data symbol and a preceding first data symbol, from said each second component symbol which corresponds with said each modelled data symbol, and to generate said estimate of each of said first component symbols, by adding said corresponding modelled data symbol to said prediction for said each first component symbol.

9. A data processor operable to generate an estimate of the first and second component source data symbols from the first and second modelled data symbols as claimed in claim 4, said data processor comprising
a reverse processor operable to generate an estimate of said second component source data symbols from the second modelled data symbols by
generating a prediction of each of said second component symbols from a comparison between an estimate of a preceding second component symbol and an estimate of at least one preceding second component data symbol,
forming an estimate of each second component symbol by combining said second modelled data symbols with each of said predictions for each of said second component symbols, and
another reverse processor operable to generate a prediction of each of said first component data symbols from the estimates of said first component symbols, and combining said predictions of first modelled data symbols with said predictions of said first component symbols.

10. A data processor as claimed in claim 9, wherein said another reverse processor is operable
to generate said prediction for each first component symbol corresponding to each first modelled data symbol by subtracting a difference between a preceding second data symbol and a preceding first data symbol, from said each second component symbol which corresponds with said each first modelled data symbol, and
to generate said estimate of each of said first component symbols, by adding said corresponding modelled data symbol to said prediction for said each first component symbol.

11. A data processor as claimed in claim 10, wherein said another reverse prediction processor re-generates said estimates of said first component symbols by adding said corresponding modelled data symbol to said prediction values, modulus the alphabet size of the modelled data symbols.

12. A method of processing data symbols from a data source, said data source having first component data and second component data, said second component data being related to said first component data, said data processor comprising the steps of
predicting each of the first component data symbols from preceding first and said second component data symbols, and
generating first modelled data symbols representative of said first component data symbols, from a difference between the prediction of each first component symbols and the corresponding first component data symbol.

13. A method of processing data symbols as claimed in claim 12, comprising
forming second modelled data symbols from said second component data symbols.

14. A method of processing data symbols as claimed in claim 13, wherein said second modelled data symbols are formed from said second component data symbols by
predicting each of said second component data symbols from preceding second component data symbols, and
forming said second modelled data symbols from a difference between the original second data symbols and the prediction.

15. A data compression encoder which is arranged in operation to generate compression encoded data from a data source having first component data and second component data, said second component data being related to said first component data, said compression encoder comprising
a pre-processor operable to generate first modelled data symbols representing symbols of said first component data from symbols of said second component data, and
a compression encoding processor coupled to said pre-processor, which is arranged in operation to generate said compression encoded data by representing said first modelled data symbols and said second component symbols as compression encoded data symbols, wherein said pre-processor generates prediction values of said first component symbols from preceding first and said second component data symbols, and forms each of said first modelled data symbols from an error between the first component symbol and the corresponding prediction value for the first component symbol.

16. A data compression encoder as claimed in claim 15, wherein said pre-processor is arranged in operation
to determine the prediction value for each first component symbol by forming a difference between a preceding first component symbol and a preceding second component symbol, corresponding to said preceding first component symbol and subtracting said difference from a second component data symbol corresponding to said each first component symbol,
to calculate a prediction error for each said first component data symbol by subtracting from each said first component data symbol said prediction value corresponding to said first component data symbol, and
to generate said first modelled data symbols from said prediction errors.

17. A data compression encoder as claimed in claim 16, wherein said pre-processor is arranged in operation to generate said modelled data symbols from each prediction error modulus the alphabet size of said modelled data symbols.

18. A data compression encoder as claimed in claim 15, wherein said pre-processor is arranged in operation to generate second modelled data symbols representative of said second component symbols, by
generating a prediction for each said second component symbol from at least one preceding second component symbol and at least one other preceding second component symbol weighted by a corresponding weighting factor, and
generating a prediction error from a difference between said each second component symbol and said prediction for each second component symbol,
forming said second modelled data symbols from said prediction error of said each second component symbol.

19. A data compression decoder which is arranged in operation to generate an estimate of first and second component source data symbols from data compression encoded data symbols generated according to claim 15, said data compression decoder comprising
a data compression decoding processor arranged to receive said compression encoded data symbols, and to generate first modelled data symbols and second component data symbols from said compression encoded data symbols, and
a post-processor coupled to the data compression decoding processor, which is arranged to generate an estimate of said first component symbol from the first modelled data symbols combined with said second component data symbols.

20. A data compression decoder as claimed in claim 19, wherein said post processor is arranged in operation
to determine the prediction value by subtracting a difference between a preceding second component data symbol estimate and a preceding first component data symbol estimate from a second component data symbol estimate which corresponds with said each modelled data symbol, and
to generate an estimate of each of said first component symbols, by adding said corresponding modelled data symbol to said prediction value for said each first data symbol.

21. A data compression decoder as claimed in claim 20, wherein said post processor re-generates said estimates of said first component data symbols by adding said corresponding modelled data symbol to said prediction values, modulus the alphabet size of the modelled data symbols.

22. A data compression decoder as claimed in claim 19, said decoder being operable to generate an estimate of said first and said second component source data symbols from compression encoded data symbols generated according to claim 18, wherein said data compression decoding processor is arranged to generate said first and second modelled data symbols from said compression encoded data symbols, and said post-processor is operable to generate a prediction of each second component data symbol from said at least one preceding second component symbol and at least one other preceding second component data symbol weighted by said corresponding weighting factor, and to generate an estimate of said second component data symbols by combining the second modelled data symbols with said prediction for each second component data symbol.

23. A method of data compression encoding first component data and second component data, said second component data being related to said first component data, said method comprising the steps of
generating first modelled data symbols representing symbols of said first component data from symbols of said second component data, and
compression encoding said first modelled data symbols and said second component symbols to generate compression encoded data symbols, wherein the step of generating the first modelled data symbols comprises the steps of
determining a prediction value for each first component symbol by subtracting a difference between a preceding first component symbol and a preceding second component symbol from the second component symbol which corresponds with each first component symbol,
calculating a prediction error for each said first component symbol by subtracting from each said first component symbol said prediction value corresponding to said first component symbol, and
generating said modelled data symbols from said prediction errors.

24. A method of data compression decoding compression encoded data to generate an estimate of first and second source data symbols, said compression encoded data symbols being generated by the method according to claim 23, said method of decoding comprising the steps of
compression decoding said compression encoded data to generate said first modelled data symbols and second component symbols from said compression encoded data symbols,
determining a prediction value for each modelled data symbol by subtracting a difference between a preceding second component symbol and a preceding first component symbol, from a second component symbol which corresponds with said each first modelled data symbol, and
generating an estimate of each said first component symbol, by adding said corresponding first modelled data symbol to said prediction value for said each first component symbol.

25. A data processor operable to represent data symbols from a data source as modelled data symbols, said data source having three related components of first, second and third data, said data processor being operable to generate first modelled data symbols representing said first component data from said second and said third component data, wherein said first modelled data symbols are representative of an error between a prediction value for the first component symbols derived from the second and third data symbols and the first data symbols.

26. A data processor as claimed in claim 25, wherein said processor is arranged in operation
to determine for each first data symbol a first relation metric and a second relation metric, said first relation metric being generated from a difference between a preceding second component symbol (Gˆ ) and a preceding first component symbol (Bˆ ), said second metric being generated from a difference between a preceding third component symbol (Rˆ ) and a preceding second component symbol (Gˆ ),
to determine for each first component symbol a third relation metric from a difference between a corresponding third component symbol (R) and a corresponding second component symbol (G),
to determine for each first component symbol whether the preceding third component symbol (Rˆ ) is equal to the preceding second component symbol (Gˆ ), and if said preceding third and second component symbols are equal (Rˆ =Gˆ ), generating a prediction value for said first component symbol from a difference between the corresponding second component symbol (G) and the corresponding first relation metric (Gˆ −Bˆ ), and if said preceding third and second data symbols are not equal (Rˆ ≠Gˆ ), generating a prediction value for said first component symbol from a difference between the corresponding second component symbol and a ratio of said first and second relation metrics scaled by said third relation metric.

27. A data compression encoder comprising
a data processor according to claim 25, and
a compression encoding processor coupled to said data processor and operable to compression encode said first modelled data symbols and symbols of said second and said third data into compression encoded data symbols.

28. A data processor which is arranged in operation to generate an estimate of first, second and third source data symbols from data compression encoded data symbols generated by the data processor according to claim 27, said data processor comprising
a data compression decoding processor arranged to receive said compression encoded data symbols, and to generate said first modelled data symbols and symbols of said second component and said third component from said compression encoded data symbols, and
a post-processor coupled to the data compression decoding processor which is arranged to generate an estimate of each of said first component symbol, from the first modelled data symbols combined with said second and third component symbols, wherein said estimate of said first component symbols are generated by adding said first modelled data symbols to a corresponding prediction value for said each first component symbol derived from the second and third component symbols and the first component symbols.

29. A data processor as claimed in claim 28, wherein said pre-processor is arranged in operation
to determine for each first modelled data symbol a first relation metric and a second relation metric, said first relation metric being generated from a difference between a preceding second component symbol (Gˆ ) and a preceding first component symbol (Bˆ ), said second metric being generated from a difference between a preceding third component symbol (Rˆ ) and a preceding second component symbol (Gˆ ),
to determine for each first component symbol a third relation metric from a difference between a corresponding third component symbol (R) and a corresponding second component symbol (G),
to determine for each first component symbol whether the preceding third component symbol (Rˆ ) is equal to the preceding second component symbol (Gˆ ), and if said preceding third and second component symbols are equal (Rˆ =Gˆ ), generating a corresponding prediction value for each said first component symbol from a difference between the corresponding second component symbol (G) and the corresponding first relation metric (Gˆ −Bˆ ), and if said preceding third and second component symbols are not equal (Rˆ #Gˆ ), generating a prediction value for said first component symbol from the corresponding second component symbol and a ratio of said first and second relation metrics scaled by said third relation metric.

30. A data processor as claimed in claim 25, wherein said first, second and third components are representative of red, green and blue components, said data being a colour image.

31. A method of processing source data comprising three related components of first, second and third data, said method comprising the steps of
determining for each first component symbol a first relation metric and a second relation metric, said first relation metric being generated from a difference between a preceding second component symbol (Gˆ ) and a preceding first component symbol (Bˆ ), said second metric being generated from a difference between a preceding third data symbol (Rˆ ) and a preceding second data symbol (Gˆ ),
determining for each first component symbol a third relation metric from a difference between a corresponding third component symbol (R) and a corresponding second component symbol (G),
determining for each first component symbol whether the preceding third component symbol (Rˆ ) is equal to the preceding second component symbol (Gˆ ), and if said preceding third and second component symbols are equal (Rˆ =Gˆ ),
generating a corresponding one of said modelled data symbols for said first component symbol from a difference between the corresponding second component symbol (G) and the corresponding first relation metric (Gˆ −Bˆ ), and if said preceding third and second component symbols are not equal (Rˆ ≠Gˆ ),
generating a prediction for each said first component data symbol from a difference between the corresponding second component symbol and a ratio of said first and second relation metrics scaled by said third relation metric, and
generating said modelled data symbol from a difference between the prediction of each first component data symbol and the corresponding original first component data symbol.

32. A method of processing data to generate an estimate of first, second and third component symbols from modelled data symbols generated by the method of processing according to claim 31, said method comprising the steps of
determining for each first modelled data symbol a first relation metric and a second relation metric, said first relation metric being generated from a difference between a preceding second component symbol (Gˆ ) and a preceding first component symbol (Bˆ ), said second metric being generated from a difference between a preceding third component symbol (Rˆ ) and a preceding second component symbol (Gˆ ),
determining for each first component symbol a third relation metric from a difference between a corresponding third component symbol (R) and a corresponding second component symbol (G),
determining for each first component symbol whether the preceding third component symbol (Rˆ ) is equal to the preceding second component symbol (Gˆ ), and if said preceding third and second component symbols are equal (Rˆ =Gˆ ),
generating a prediction of each said first component symbol from a difference between the corresponding second component symbol (G) and the corresponding first relation metric (Gˆ −Bˆ ), and if said preceding third and second component symbols are not equal (Rˆ ≠Gˆ ),
generating the prediction of said first component symbol from a difference between the corresponding second component symbol and a ratio of said first and second relation metrics scaled by said third relation metric, and
generating an estimate of each said first component data symbol from a combination of said predicted first component data symbol and said corresponding modelled data symbol.

33. A signal representing data generated by the data processor or the data compression encoder according to claim 1.

34. A carrier comprising a recording/reproducing medium having a signal according to claim 33 recorded thereon.

35. A computer program providing computer executable instructions, which when loaded onto a computer configures the computer to operate as a data processor according to claim 1.

36. A computer program providing computer executable instructions which when loaded onto a computer configures the computer to operate as a data compression encoder according to claim 15.

37. A computer program providing computer executable instructions which when loaded onto a computer configures the computer to operate as a data compression decoder according to claim 19.

38. A computer program providing computer executable instructions, which when loaded on to a computer causes the computer to perform the method according to claim 12.

39. A computer program product having a computer readable medium having recorded thereon information signals representative of the computer program claimed in claim 35.
